(19) United States
(12) Patent Application Publication
(10) Pub. No.: US 2006/0116908 A1
(43) Pub. Date: Jun. 1, 2006

(54) Web-based data entry system and method for generating medical records

(76) Inventors: Douglas Keith Dew, Palm Coast, FL (US); Steven J. Halpern, Oviedo, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/326,910

(22) Filed: Jan. 7, 2006

Related U.S. Application Data
(63) Continuation-in-part of application No. 10/209,647, filed on Jul. 30, 2002.
(60) Provisional application No. 60/308,771, filed on Jul. 30, 2001.

(51) Int. Cl. G06Q 10/00

(52) U.S. Cl. 705/2

(57) ABSTRACT

An apparatus and method for generating a patient's medical record. The apparatus comprises a data input component that executes through a plurality of clinical, tree-like pathways that are traversed as data describing the patient's condition is entered, for example, by the physician during a clinical examination. At each node, the physician is prompted as to the additional health information required to traverse the clinical pathway. Once an end “leaf” is reached, the medical record is generated based on the path traversed through the clinical pathway. A web site stores the record for access via a web browser.

### CROSS REFERENCE TO RELATED APPLICATIONS

The present patent application is a continuation-in-part application claiming the benefit of the patent application assigned application Ser. No. 10/209,647 filed on Jul. 30, 2002, which claims the benefit of the provisional patent application assigned Ser. No. 60/308,771 filed on Jul. 30, 2001.

### FIELD OF THE INVENTION

The present invention is directed generally to patient medical records and more particularly to an apparatus, method and computer software for assisting with the diagnoses of a patient's medical condition and for generating a patient medical record.

### BACKGROUND OF THE INVENTION

The generation and management of patient medical records is a critical function for medical facilities, including physician offices, clinics, laboratories, hospitals, and outpatient treatment facilities. The records serve different functions for each party delivering medical services to the patient. The patient's medical file also includes information from many different sources and in many different formats. The records include critical information necessary for providing appropriate health care to the patient, including a medical history, results and impressions of physician examinations, treatment plans, administered prescription and non-prescription drugs, laboratory test results, etc.

The records also contain information required for prompt and accurate patient billing and for reimbursement of the medical services provider by the patient or a third party, such as an insurance carrier or government agency. In particular, the records contain the treatment and procedure codes used by payors to identify the services rendered and permit appropriate payment to the provider.

The medical records are subject to periodic audit by government agencies to review an attending physician's credentials or a hospital's certification. The records can also include useful evidence for the plaintiff and the defendant in medical malpractice actions.

For the individual physician, an important component of the medical record is the record created during the office visit. The office visit begins with the patient supplying a medical history to the physician. The patient completes a medical history form by checking boxes and adding supplemental free-form information and explanatory comments. The patient may be assisted in this process by a member of the physician's staff. Certain routine procedures are then conducted, for example, the patient's height, weight and blood pressure are measured and the results noted in the record. Next the physician conducts the examination, during which current symptoms, if any, are identified. As the examination proceeds, the physician arrives at an impression of the patient's condition. If further tests or examinations are warranted, the physician explains the procedure plan under which additional tests will be administered and a treatment plan for the observed conditions.

After the examination, the patient is dismissed by the nurse and given an office visit summary that includes a description of the examinations conducted, a summary of the ordered procedures and a schedule for follow-up visits. The patient gives the summary to a member of the office staff, who receives the payment from the patient and makes the necessary follow-up procedure and office visit appointments. The office staff then assigns the appropriate medical procedure codes to the services rendered and forwards the information to the insurance carrier or government agency for payment.

Immediately after the examination, the physician creates a record detailing the interactions with the patient during the visit. Conventionally, the physician uses a dictation recording device that records the spoken dictation onto a magnetic recording tape. Alternatively, the physician dictates into a telephone-like device connected to a remote transcription facility. The information dictated includes the symptoms presented by the patient, the nature and results of the office physical examination, the physician's impression and primary and secondary diagnosis, discussions with the patient about any current conditions and the care plan including recommended additional tests or procedures and the proposed treatment. After completing the dictation, the magnetic or optical medium storing the dictation is given to a medical transcriptionist for generating the written record from the transcribed dictation. The written transcript is later checked by the physician or a member of the physician's staff. Although the transcriptionist is typically trained in medical terminology, mistakes are made and corrections required. Finally, the transcribed document, typically in paper form, becomes a part of the patient's permanent record.

Although the creation of the patient's record has been described in conjunction with a doctor's office visit, the medical record is updated after each interaction between the physician and the patient. For example, after a surgical procedure the physician dictates the details of the surgical procedure for inclusion in the written record. When the results of a medical procedure or test become available, a notation is added to the file as to the medical significance of the reported results. Hospital stays also require a physician or para-professional to generate a detailed record of the stay and a discharge summary. As described, certain elements of these records represent instructions to the patient and others are for payment and insurance purposes.

In lieu of free-text dictation process described above, certain computer-based medical records systems use a locally-stored database of text macros (i.e. “canned” phrases) selectable by the physician to create text strings for entry to the patient's record. The available text strings describe elements commonly found in medical history entries, doctor's observations, impressions and treatment plans. During the dictation process the physician selects relevant strings and adds free-text information to create the patient's record. Use of the text macros may save the physician some dictation time. However, the use of dictation devices, the requirement for transcriptionist services and the need to review the transcribed text are time consuming and costly tasks.

There are also known software programs that convert the physician's spoken word directly to a text document, avoiding the transcription step. However, these programs must be trained to the individual user's voice characteristics and sometimes fail to accurately convert to the correct word. These systems find limited use in the medical field where absolute accuracy is required.

After creating the medical record it must be stored according to a process that permits efficient record locating, retrieval and updating. Existing electronic medical record (EMR) software-based applications require specialized hardware and proprietary software, such as database servers, third-party database software applications and software maintenance contracts. Additionally, the EMR hardware and software components must be compatible with and configured to communicate with other physician office hardware and software. A physician having multiple offices incurs additional complexities and costs associated with creating and implementing a local area network or virtual private network (VPN) to allow data exchange and file transfer between offices. Finally, there are the expected problematic incompatibilities between hardware and software components and among software components, as well as technology changes and software upgrades.

There remains a need for a system and method for generating accurate and complete patient records with efficiency and dispatch. The system should reduce the time and costs required to create, store, retrieve and update medical records by automating one or more of these processes.

### BRIEF SUMMARY OF THE INVENTION

According to one embodiment, the present invention comprises an apparatus for producing a patient medical record. The apparatus comprises an information receiving component operative by an inputting user who supplies patient health information to the receiving component; an analysis component receiving the health information from the receiving component, the analysis component traversing a traversal path through a clinical pathway responsive to the health information, wherein the clinical pathway comprises hierarchical nodes joined by interconnecting branches; an output component generating the medical record in response to the traversal path and a storage component storing the medical record as a data file. According to another embodiment, the invention comprises a method for generating a patient's medical record. The method comprises issuing prompts for entry of patient health information, wherein each prompt is associated with a node of a clinical pathway; entering the patient health information in response to the prompts, wherein data entered responsive to a current prompt at a current node generates a subsequent prompt associated with a subsequent node according to a path of the clinical pathway from the current node to the subsequent node; producing the medical record responsive to nodes encountered and heath information entered along the path traversed through the clinical pathway and storing the medical record as a data file.

### BRIEF DESCRIPTION OF THE DRAWINGS

The foregoing and other features of this invention will be apparent from the following more particular description of the invention, as illustrated in the accompanying drawings, in which like reference characters refer to the same parts throughout the different figures.

FIG. 1 is a block diagram of a medical records generating apparatus according to the teachings of the present invention;

FIG. 2 illustrates a flowchart of the steps associated with generating the medical record;

FIGS. 3 and 4 illustrate clinical pathways for generating the medical record;

FIG. 5 is a pictorial representation of the data input/output device of FIG. 1;

FIG. 6 is an exemplary image on the display screen of the data input/output device; and

FIGS. 7 and 8 are block diagrams of medical records generating apparatuses according to the teachings of the present invention.

### DETAILED DESCRIPTION OF THE INVENTION

Before describing in detail the particular automated patient record generating system, method and software in accordance with the present invention, it should be observed that the present invention resides primarily in a novel combination of hardware and software elements. Accordingly, these elements have been represented by conventional elements in the drawings, showing only those specific details that are pertinent to the present invention, so as not to obscure the disclosure with structural details that will be readily apparent to those skilled in the art having the benefit of the description herein.

According to the present invention, software programs and related system hardware elements generate a Health Care Finance Administration-compliant patient medical record. In one embodiment, portions of the record are generated according to pre-examination clinical pathways (also referred to as flow charts or decision trees). Each pathway is structured as a decision tree with alternative branches extending from each tree node (decision node). Entry of patient information selects a branch extending from each node, creating a traversal path through the decision tree, the path comprising nodes and the selected branch extending from each node. Preferably the data entry and path traversal process are software-controlled, with the pathway elements embodied within the software programs, preferably as ASCII text or html files.

The apparatus and method of the present invention, in one embodiment, generates a patient record in text format, graphical format and database format. The text version is useful for broad record searches that would return a list of patient records based on a search query. For example, all records of patients suffering from hypertension can be identified and retrieved. The graphical record format locks the record in time by capturing the record as an image. The image version of the record is stored, but cannot be updated, amended or modified. The database format is especially useful for searching individual fields within the record. Exemplary searchable fields (which can be combined according to Boolean operations) include the ICD9 codes, diagnosis codes, procedure codes, allergy types, medications administered, age and sex.

By using the clinical pathways (or clinical guidelines) according to the present invention, the physician creates the patient record based on the output branches he selects (or selected for him under software control) responsive to the condition or patient health information he enters at each node. Information entry and the output branch selection responsive thereto traverse a path through the clinical pathway. The generated medical record captures the data entered and the path traversed.

At each pathway node the physician is prompted to enter patient condition information (e.g., blood pressure, presence of pain). As the physician responds to the prompts by entering the requested information, the software clinical pathway logic selects the appropriate branch, responsive to the entered information, that extends from the current node to a subsequent node. At the subsequent node the physician again responds to the node prompt and follows the selected branch. In another embodiment each prompt presents candidate responses. By selecting the most appropriate response from among those presented, the physician is directed to the next node responsive to the selected response.

The pathway tree is traversed to an end node (leaf) that presents an impression, diagnosis or treatment plan, or to a node that indicates the need for additional information, e.g., the need for additional medical tests. In one embodiment certain nodes (especially end nodes) include a link (such as a hyperlink) to additional information, such as detailed medical information or advertising information for a medication or device for ameliorating the diagnosed condition.

As follow-up test results become available, they are entered into the clinical pathways. Traversal of the pathways continues until the decision tree identifies a final diagnosis and generates a care plan, e.g., nature of the disease, condition or injury, patient education information, possible adverse outcomes of the disease, adverse outcomes of the treatment, differential diagnoses, risk factors and history.

The path traversed through the tree and the conclusions reached during the traversal to the end nodes are recorded according to the present invention to generate the patient's medical record. This medical record is more detailed than a conventionally dictated record. Further, because the record is generated in response to decision-tree prompts, the record includes the results of an examination directed by medically accepted clinical pathways. Use of the decision tree structure thus enhances the probability of a correct diagnosis, while providing automatic “dictation” based on the clinical path traversed and the information supplied. The record is accurately generated at the point of care and provides sufficient detail with marked reduction in transcription costs and physician dictation time. Advantageously, the system helps the physician better manage his time, reduces office paper work, reduces time required to generate the proper medical records and formulates a care plan that is available to the patient in printed form prior to leaving the office. The invention eliminates the detailed dictating process and subsequent transcription of the prior art.

The patient's record generated according to the present invention also includes ordered procedural tests, follow-up notes, informed consent forms, operative notes, procedure notes, referral request letters, consult response letters, and the ICD-9 and CPT procedure and diagnosis codes used by insurance carrier. The inclusion of these diagnosis and treatment codes simplifies the billing, utilization review and payment processes. The system provides compliant documentation for Medicare, Medicaid, utilization review, workman's compensation, managed care, insurance reimbursement, specialist referrals, and primary care physician review. These reports are generated by the system and method of the present invention based on the path traversed through the clinical pathway and the supplied patient condition information.

The system of the present invention saves dictation costs not only for the physician's office but also for ambulatory surgery centers and hospitals. The system provides automated generation of the patient's chart and updates thereto for initial in-patient consults, routine operative notes, routine hospital follow-up and complete office examinations. The system can be used by medical personnel to record the details of every interaction with a patient. Further, because the system is based on accepted clinical pathways, it generates a medically acceptable care plan for the patient.

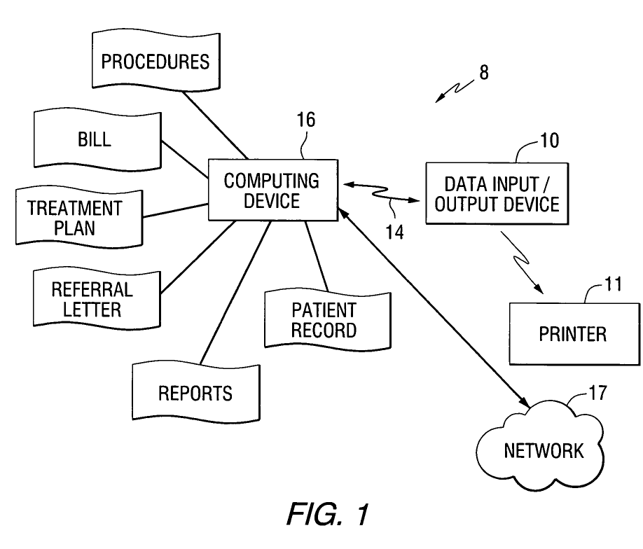

A system 8 (see FIG. 1) according to one embodiment of the present invention includes a data input/output device 10 executing a software program for creating, accessing, amending, etc., a patient's medical records. The data input/output device 10 comprises a handheld computing/data processing device, such as Compaq iPAQ, available from Hewlett Packard Corporation of Palo Alto, Calif., running a Windows CE® or Windows® (trademark of Microsoft Corporation) operating system. In particular, a Compaq iPAQ pocket personal computer Model 3670 with 64 Mb of memory is a suitable hardware platform. In another embodiment the data input/output device 10 comprises a personal digital assistant, such as a Dell Axim or Palm PDA. In yet another embodiment, a portable or desk top computer, a Blackberry wireless device or a cellular telephone providing text messaging and web access are suitable for use as the data input/output device 10. Any wired or wireless device having basic data entry capabilities, e.g., text and speech, and capable of accessing the system 8 can be used as the data input/output device 10.

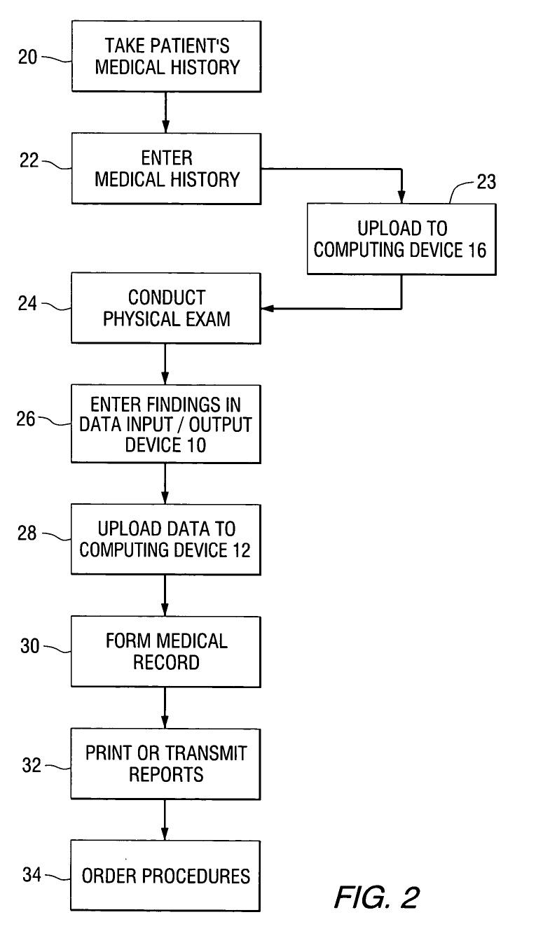

The clinical pathway, including its nodes and interconnecting branches, executes using a word processor or another program capable of creating and editing text (such as Microsoft Pocket Word or Microsoft Word) and a directory-based operating system (such as Microsoft Windows). Alternatively, the decision tree structure is operative using a web browser and/or a browser-based operating system. Traversal of the tree is described below in conjunction with the FIG. 2 flowchart.

In lieu of or in addition to storing the patient records in the data input/output device 10, in another embodiment, the examination results are entered into the data input/output device 10 and communicated over a link 14 to a computing device 16 (e.g., a desktop, laptop or notebook computer) for generating the medical record according to a path traversed through the clinical pathway, storing the patient's medical record and generating other reports, documents, appointment reminders and referral letters as described elsewhere herein. The computing device 16, interacting with other computing devices over a network 17 can command the other computing devices to schedule follow-up procedures, tests and examinations. The computing device 16 can also provide the medical record or associated records and documents derived therefrom to other sites, such as an insurance carrier site for processing an insurance claim, via the network 17. In addition to storing the medical record and related documents internally and/or on a separate computer, such as a web server, the computing device 16 can copy and/or store the medical record on a removable media storage device such as a CD-ROM or a memory stick.

The data input/output device 10 includes one or more of an infrared port, a radio frequency wireless transceiver or a wired port for communicating with the computing device 16 over the link 14. The data input/output device 10 can include a port for connection to a memory element for supplementing the memory capacity of the device 10 or for backing-up the information stored therein. In one embodiment, the data input/output device 10 communicates (for example, over an infrared communications link) with a printer 11 for printing the medical record.

Although preferably a hand held or portable device, in another embodiment the data input/output device comprises a desktop, laptop or notebook computer (not shown) capable of receiving and operating on information entered as text or speech. Also, the data input/output device 10 and the computing device 16 can be implemented as a unitary device, although such an embodiment may not provide the preferred portable feature for the data input/output device 10.

Since patient data can also be entered directly to the computing device 16, it may be necessary to synchronize the stored information in the two devices using known file synchronization techniques. Back-up or redundant files can be stored at another location and/or in another data processing or computing device for retrieval if the primary files stored in the computing device 16 and/or the data input/output device 10 are lost or corrupted.

Several exemplary documents generated according to the teachings of the present invention are depicted in FIG. 1. Additional indicated procedures, such as x-rays and blood work, are automatically ordered and scheduled. The patient's bill, treatment plan, and informed consent forms are printed. Referral letters and reports from a specialist to a primary care physician are assembled and printed from the computing device 16. Reports and billing information for the insurance carrier and government health care agencies are generated. The decisional clinical pathways of the present invention allow the automatic assignment of appropriate procedure and diagnosis codes (to facilitate for insurance processing) as branches of the pathway are encountered during the examination process.

FIG. 2 is a flowchart illustrating the steps associated with a patient's visit to a physician's office. This is presented merely as an example of one application of the present invention, as the basic concepts of the invention can be employed by any medical service provider to generate medical records describing the services provided.

At a step 20, the details of the patient's present illness and past medical history are taken and recorded. Conventionally, this is accomplished by having the patient complete a preprinted medical history form that includes the patient's name, identification number, site (office or hospital), date of encounter, insurance information, primary care physician, date of injury (if any), whether the injury is work related, list of present medications, past medical history, past surgical history, family history, social history and any present symptoms. Office staff begin the process of creating the medical record or patient record by entering the demographic and medical history information from the medical history form into the computing device 16 (or into the data input/output device 10) See a step 22. For example, the electronic record may be in the form of a Microsoft Word document on the computing device 16. The document comprises an established format or template that the staff member populates with the information taken from the patient's medical history form. At this stage, patient identification labels can be pre-printed for later attachment to the various reports, letters, procedure results, etc. that are generated in conjunction with the medical services rendered. As depicted by a step 23, the entered information is uploaded to the computing device 16 of FIG. 1 for storing.

At a step 24, the physician conducts a physical examination of the patient with particular attention to any present symptoms. As indicated at a step 26, during the examination the physician enters examination findings into the clinical pathway presented by the data input/output device 10. In another embodiment, the physician enters the findings into the data input/output device 10 after the examination has been completed. However, data entry concurrent with examination is preferable, as the clinical pathway structure assists (prompts) the physician by identifying examination processes that the physician should consider or conduct to accurately diagnose existing medical conditions. Alternatively, the findings can be entered by a para-professional during or following the examination under the direction of the examining physician.

According to a preferred embodiment, a plurality of clinical pathways (decision trees) are available for use by the physician to assist in properly diagnosing the patient's condition. The physician selects the most pertinent pathway based on the patient's condition and presented symptoms.

The patient's condition is evaluated as the physician traverses a path through the clinical pathways, inputting patient information responsive to prompts at each node and directed to a subsequent node (via an output branch) responsive to the entered information. The nodes can be files preferably named according to an anatomical or clinical relevance of the node. In one embodiment, certain node files contain text information that solicits additional information (prompts) or provides instructions to the physician to assist in determining the output branch from that particular tree node. Files can also contain visual images to assist the physician with the examination process prompted by the node. The nodes and branches of the clinical pathways are updated as new pathways are generated by federal government agencies, specialty medical societies or other medical-related organizations.

In one embodiment, each clinical pathway node comprises one or more output branches, each branch associated with a potential or candidate response to the inquiry at the node. When the physician identifies the most appropriate response, she is directed along the associated output branch. Certain intermediate nodes present tentative findings or conclusions as to the patient's condition. Other intermediate nodes suggest collecting additional patient information, e.g., laboratory tests or clinical examinations. The selected path leads to a subsequent node (a file) that includes proposed findings responsive to the path traversed to that node and/or prompts for additional information.

When traversal of the pathway reaches an end node, the process terminates and an ASCII-formatted file (or another format if desired) is created to store the clinical impression, results, path traversed, input information, suggested tests, etc. as derived from the pathway. The file can be read by a text editor or by a word processing program, such as Microsoft Pocket Word® or Microsoft Word®. In addition to the records and reports generated by traversing a path through the pathway, the physician can add an addendum (e.g., free text information) to the generated medical record.

The generated medical records file is assigned a file record number and associated with the patient through a patient identification number (or other patient indicia) further described below.

Since the file stores all relevant information derived from the patient encounter and the subsequent diagnostic evaluation, including the path traversed through the decision tree, it comprises a relatively complete patient chart or record. If desired, the chart can be stored within the data input/output device 10 for later use by the physician or her staff. For example, when the physician visits the patient during hospital rounds the patient's record is readily and conveniently available on the data input/output device 10. The clinical pathway also comprises one or more of patient progress notes, care plan notes, physical therapy procedures and allied health care services.

Returning to the FIG. 2 flowchart, following the examination, at a step 28 the data is uploaded from the data input/output device 10 to the computing device 16 over the communications link 14 of FIG. 1. Alternatively, the data input/output device 10 is mated with the computing device 16 through a docking station or the data is uploaded as it is entered. There are several available techniques for accomplishing the data transfer process (and data file synchronization if required) between the data input/output device 10 and the computing device 16. In lieu of or in addition to the data transfer to the computing device 16, the data can be transferred from the data input/output device 10 to the printer 11 for generating a hard copy record.

At a step 30, the downloaded information (including results of the examination and care plan information as determined from the clinical pathway and addenda added by the physician) is combined with the preliminary medical record that was created at the step 22, forming a complete medical record that includes all relevant information collected to this point in the medical care delivery process.

In the preferred embodiment the record is stored in digital form at a networked site to permit easy access by authorized personnel. Certain personnel may be granted read-only access while others may be permitted to append to the patient's record to store new information therein.

In an exemplary embodiment the medical record is saved in ASCII (preferred in one embodiment) database and image (such as JPG or TIFF) formats. In a preferred embodiment, the ASCII files can only be appended; no changes are allowed. The text file can also be searched. The image files are frozen in time to create a permanent record that is locked and unalterable. Either file type can be emailed or transmitted to a third party. In one embodiment a patient photo for identification verification is supplied with the file, permitting the third party to confirm that the correct file was provided. Preferably, file encryption is not required since the medical record file (either in text or image format) contains no patient identifying information.

An office staff member operates the computing device 16, as indicated at a step 32, to print or transmit reports derived form the medical record. For instance, the medical record includes the various predetermined codes that identify the nature and extent of the physician's examination. This information is used to generate the invoice, which will include the billing codes, for use by the physician's billing personnel to determine the applicable fees and the segregation of that fee into the patient's share and the insurance carrier's share, if applicable. Another segment of the medical record includes the patient's care plan, including physician-advised treatments (e.g., prescription drugs, exercises, patient limitations or constraints) and additional ordered procedures such as x-rays, blood work, etc.

In addition to generating the various reports, if operative intervention is indicated, an informed consent form is created, including a recitation of the possible complications, alternative treatments, advice on seeking a second opinion, infection rates, and expected outcomes of the planned procedure. The nature of the consent required and the details of the operative intervention are determined based on the outcome of the decision tree clinical pathway process.

For insurance claim processing, letters of authorization for operative procedures and diagnostic tests are automatically generated. Insurance carrier correspondence such as replies to denial letters, re-processing letters, medical necessity letters, assumption of care letters, and letters for reconsideration of unlisted codes can be automatically generated when needed.

It is known that insurance carriers require pre-approval prior to the administration of certain tests and procedures. According to current practice, the carrier reviews the patient's medical record to determine whether certain conditions are present to warrant the procedure. If the conditions are satisfied, the procedure is approved. According to the present invention, the insurance carrier can insert these conditional prerequisites into the clinical pathways and thereby avoid the necessity of a pre-approval for a procedure that is on the pathway. For example, assume a given procedure requires pre-approval and the pre-approval is routinely granted only if conditions A and B are presented. The insurance carrier and physician can avoid the pre-approval process by including the procedure in the decision tree only along a path that confirms the conditions A and B are present.

The process of extracting the relevant information from the medical records and generating the reports is simplified by the use of the aforementioned clinical pathways. For example, certain clinical pathways require a referral to a specialist and thus the computing device 16 generates the referral letter, including in the letter relevant medical history and condition information available to date. A determination by the application software that a particular node was reached automatically generates the referral letter.

At a step 34, the computing device 16 orders the additional procedures suggested by the clinical pathway. For example, if an x-ray is required, the computing device 16 checks the x-ray department schedule and schedules the x-ray for the patient.

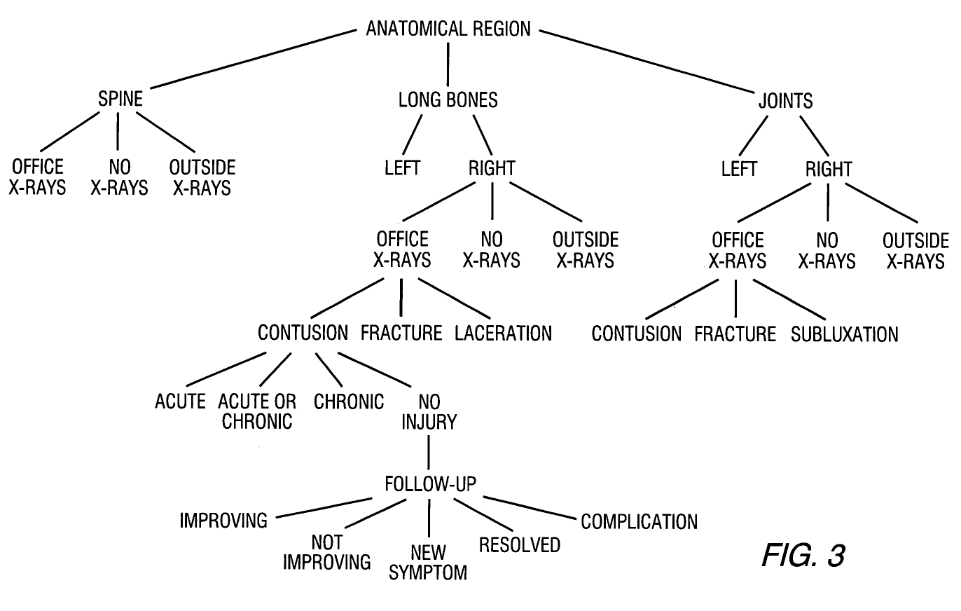

Exemplary partial clinical pathways for orthopedic surgeons are set forth in FIG. 3. The pathways can be represented as a hierarchical branching tree of files and subfiles (nodes). The physician traverses through the pathway by selecting the most relevant subfile branching from the current subfile. Certain subfiles prompt the physician with a question to which he/she provides an answer (i.e., yes, no or equivocal), where the answer determines the next subfile or node along the traversed path.

The pathways can include Boolean logic operators for stringing together multiple findings to determine the next traversed (output) branch from a node. Differential diagnoses (i.e., equivocal findings) can also be incorporated into the tree. In this case, the pathway can be traversed through multiple parallel paths until the equivocal finding is resolved and the correct diagnosis identified. The pathway structure includes consideration of the degree of severity of the patient's condition, e.g., chronic, acute, infrequent. An index of the pathways in the decision tree structure is also presented for review by the physician.

For orthopedic applications, the pathways are segregated into regional anatomical areas (for example, the spine, long bones, and joints). The next node prompts for the left or right side of the body, where applicable. The next nodes request x-ray status and findings information (no films taken, outside x-ray findings, or office x-ray findings).

For joints, the next node level or subfile is divided into the possible joint conditions, including contusion, fracture, dislocation, subluxation, laceration, sprain, and no subluxation. For long bones, the next node level or subfile is divided into contusion, fracture, or laceration. The nature of the injury is then identified (acute injury, acute on chronic, chronic problem, no injury, or follow-up examination). The follow-up examination branch (traversed at the time of the follow-up examination) includes candidate selections, improving, not improving, new symptom, resolved or complication.

Thus as the pathway is traversed, the clinical findings are entered as positive, negative or equivocal through the selection of the appropriate branch leading from a node. The resulting traversed path leads to a pre-formulated impression and care plan complete with diagnosis coding, procedure coding (such as injections, X-ray report, work status, recommended diagnostic tests, and/or referral plans). In addition, the medical report codes and documents use of casting materials, medications and other supplies.

The clinical pathway structure provides an examination and treatment algorithm derived from evidence-based medicine since all decision steps or nodes are reviewed by the physician and answered yes/no/maybe or examination information is entered. No step or parts of a clinical exam or treatment regimen can be missed when the pathway is followed. The doctor is not selecting positive findings from a list to assemble an examination note or record, as in know electronic medical record systems. Instead, the physician follows a clinical pathway (clinical care guideline or critical pathway) to arrive at the diagnosis and treatment plan. By following each step of the pathway the patient's condition is accurately diagnosed and the preferred medical treatment suggested. Thus patient recovery time improves, hospital stays are shortened, deviations from the “accepted the standard of care” are minimal and diagnostic testing, surgical treatment and medical treatment are provided only when medically necessary.

The use of documented and approved clinical pathways provides consistent and standardized nomenclature for labeling medical conditions. The use of nonstandard nomenclature in medical records causes difficulties with record interpretation and may detrimentally impact a patient's diagnosis and recovery.

A second exemplary clinical pathway related to a hypertension condition is illustrated in FIG. 4. The patient's blood pressure is measured; the systolic and diastolic readings permit the physician to select one of the four initial paths from the measurement node. As can be seen, each candidate path relates to a limit or range for each blood pressure reading and certain paths relate to a logical combination of the two readings. Continuing from the four initial paths, a systolic pressure less than X mm Hg results in a diagnosis that an identified condition exits and suggests a treatment plan. A systolic pressure less than X and the patient's complaints of weakness lead to a pathway indicating that an identified test procedure should be conducted. In this embodiment, the physician selects a path from the procedure node based on the measured pressures. The paths selected by the physician and the information entered (e.g., blood pressure) are recorded according to the teachings of the present invention to generate the medical record.

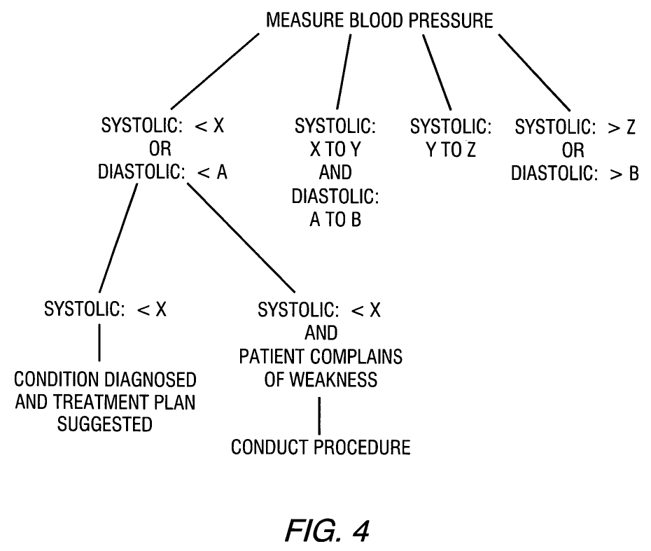

A detailed view of an exemplary data input/output device 10, illustrated in FIG. 5, comprises a display 50 and a keypad 52. Free text information can be entered into the data input/output device 10 via the keypad at any step along the clinical pathway and referenced back to a previous entry if desired. The pathway branches are displayed as icons on the display 50 and in an embodiment where the display 50 includes touch screen capabilities; the clinical path is selected by touching the icon that represents the desired path, such as the results of a clinical examination test. Voice commands received by the data input/output device 10 can also be used to supply inputs to the clinical pathway analysis process.

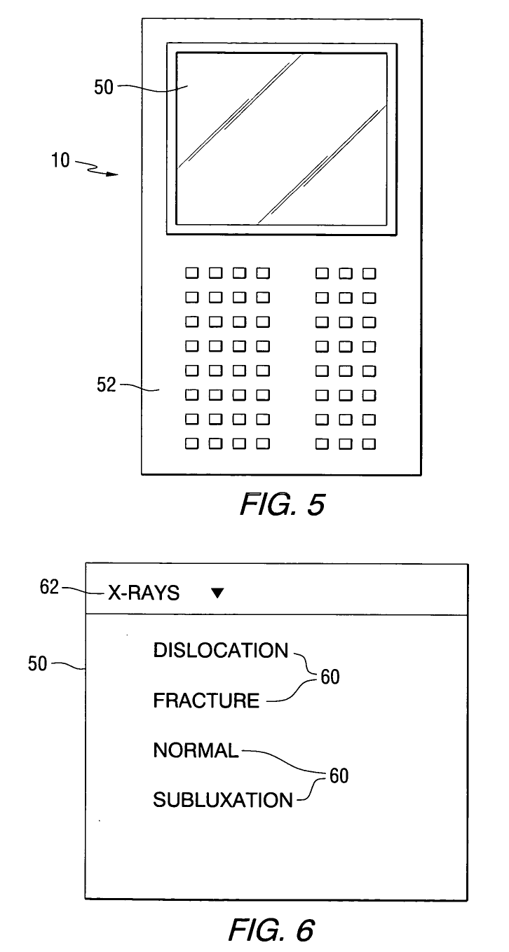

FIG. 6 illustrates an exemplary image on the display 50, including a plurality of nodes or subfiles 60 branching from a higher-level node or subfile 62. In the embodiment where the screen 50 comprises a touch screen, the physician touches the appropriate subfile 60, opening a plurality of additional subfiles branching from the opened subfile 60.

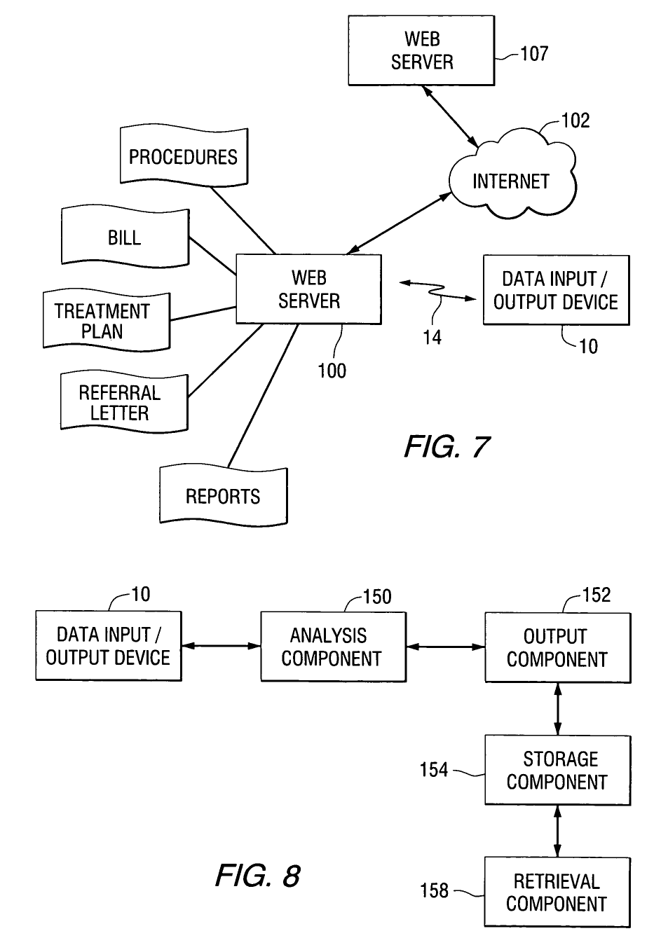

In another embodiment of the present invention, the patient records are stored as one or more web pages (preferably in text/ASCII or Microsoft Word® format) on a web server 100 of FIG. 7. According to the FIG. 7 embodiment, the data input/output device 10 interfaces with the web server 100 to create the medical records, where the web server 100 includes the functionality of the computing device 16 of the FIG. 1 embodiment. However this is not a required system configuration, as in another embodiment the data input/output device 10 interfaces with the computing device 16 that in turn interfaces with the web server 100.

As illustrated in FIG. 7, the web server 100 is connected to the Internet 102 to provide Internet-based access (via a web browser 104, for example) to the patient's records stored on the server 100. The patient records can be transmitted to a third party as an email attachment or transmitted via other network protocols to a third party. As described further below, according to one embodiment the patient's medical record does not include any patient-identifying information (e.g. name, address, social security number) and thus breach of confidentiality issues are avoided and patient approval may not be required for review of the record by a third party.

Preferably, the patient's medical records do not reveal or contain any information from which the patient can be identified. Thus a patient identification record, including identification information such as name, address, social security number, is separately maintained. To maintain patient confidentiality and provide anonymous but correct patient medical records, storage of the patient medical records and the patient identification records can be segregated between multiple applications, databases and/or servers. For example, a first application/system controls the patient identification records and a second application/system controls the patent medical records.

The patient identification record can include a permanent patient identification number (also known as a universal patient identification number) and the patient's identification information, e.g., name, social security number, birth date, address, telephone numbers. The patient identification record does not include any medical information. The patient identification number serves as a link between the patient's medical records and the patient's identification record. All medical records created by any physician for a specific patient must bear the same patient identification number.

The separate patient medical record includes only the patient identification number, or another patient-identifying indicia, and the patient's medical information. In one embodiment, the patient-identifying indicia comprises a patient photograph (or other biometric identifying information). The medical record include no other patient identifying information (e.g., name, address). A user retrieves a patient's medical record using the patient identification number or other patient identifying indicia. But before the user can open a patient's medical record, according to one embodiment a patient photograph is displayed and the user must confirm that the photograph displayed is an image of the patient whose medical record was requested. When the user confirms that the correct patient record has been accessed, by entering a reply through the browser for example, the patient's medical record is displayed. The system does not supply patient identification information, for example a name or a record number, with the photograph or with the medical record, thereby maintaining record confidentiality.

User access to the patient medical records and patient identification records is controlled by an access authentication process described below.

A patient's permanent identification number can be randomly generated by the Internet-based system and assigned to the patient. Alternatively, the physician's office can assign the number by selecting one number from a group of numbers reserved for the office's patients. Duplicate identification numbers must be avoided.

In another embodiment, the patient identification number comprises a first field identifying the responsible physician and a second field identifying a specific patient. The use of two record fields can be advantageous during record searching and data mining as described below.

Use of the web server 100 to store and retrieve the patient's identification record and medical record allows access from any Internet-accessible computer with web browsing functionality. When it is desired to access a patient's medical or identification record, the user logs on to the web server 100 through a web browser by entering a web site address and supplying a password and/or additional authentication information. The log-on process and all subsequent transactions are conducted over a secure network connection.

After authentication, the user can either enter an existing patient identification number or create a new patient identification record. For an existing patient, the user enters the patient identification number to retrieve the patient's medical record from the secure patient identification records database/server/application as described above. If the user does not know the patient's identification number, she first queries the patient identification records, retrieves the desired patient identification record and acquires the patient's identification number from the identification record. The patient's medical record is accessed using the patient identification number.

For a new patient the user logs into the secure and physically separate patient identification records. The user enters the required patient identification information after which the server/application/system assigns a unique patient identification number to the new patient. The new patient identification record can be stored electronically on the user's local system, stored remotely or printed as a hard copy.

Records of current patients are retrievable when the user supplies the patient identification number or other patient-identifying indicia. If the user desires to retrieve a patient's identification record or medical record without knowledge of the patient's identification number, the user queries the list of patients in the patient records system by searching based on patient-identifying indicia (such as biometric information) or by keyword searching based on known elements or attributes of the patient's medical record. Only those patients records to which the user has authorized access can be queried and retrieved. In response to a successful search, either based on a known patient identification number or responsive to a search query, the patient's records are retrieved for display. In a browser-based embodiment, the medical record is displayed in the browser window.

In addition to system access control, access to each individual medical record is controlled. The patient's identification and medical records are provided to the requesting or retrieving party only if the user has been granted access to the requested records. For example, the attending physician and his staff can access records of all patients under their care, that is, all records they created. A patient can access his personal records if the physician has provided the patient with the patient identification number. A physician specialist or consulting physician can access the records only for the patients he is treating. An attorney engaged in a negligence lawsuit involving bodily injury can access only the record of his client/patient and the access is restricted to read-only. However, record access by third parties (e.g., the patient, specialist, insurance carrier) requires approval by the physician creating the record and the patient. Once approval is secured, the access and retrieval system is updated to recognize and permit access (i.e. authenticate) by the approved third party.

Health insurance carriers can access the records of their insured patients. As described above, insurance claim information derived from the patient's records by the computing device 16 or the web server 100 is sent to the carrier's site for claim processing. With the patient's and physician's approval, the carrier can access the patient's records to complete the reimbursement process.

As can be appreciated, the present invention offers more efficient and less costly records creation and access, avoiding the time intensive tasks of retrieving paper-based records, copying the records, mailing the records to requesting third party such as an insurance carrier and refiling the records.

Since no patient identification information is stored in the medical record (except the patient's identification number or indicia, which is linked to a patient only within the patient identification database accessible only by the responsible physician and his staff) authorized users can search multiple patient records using the web browser's search capability, including keyword searching, without breaching patient confidentiality requirements.

Preferably, the patient records are stored as ASCII files. Since ASCII is a standard format for word processing, data manipulation, searching and data mining applications, the medical records file can be easily imported into other software applications for further processing. The patient records can also be stored in Microsoft® Word format. The medical record is also captured and stored as a fixed image that cannot be amended or changed. Fields from the patient's medical record are stored as a database file to facilitate detailed searching in response to user provided queries.

In another embodiment, the Internet 102 is replaced by a local or a wide area network providing medical records access only to those who can access the local or wide area network.

In yet another embodiment, in addition to storing and retrieving the medical records, the web server 100 stores the software code for displaying the clinical pathways, controlling data entry, creating the medical and identification records and generating the reports, correspondence, etc. (as described in conjunction with the embodiment of FIG. 1). The clinical pathways are implemented by executing software and displayed in web pages.

In this embodiment the data input/output device 10 comprises any of the various data processing and computing devices described herein, including but not limited to, a handheld device, a laptop, notebook or desktop computer or a wireless communications device including data entry and communications features. In addition to providing data entry mechanisms, a web browser executing on the data input/output device 10 displays the various elements (e.g., clinical pathways, medical records, identification records) associated with the present invention.

The system also allows the patient to enter medical history and current medical condition information (for example, current medical complaints) by patient access to the web site via a web browser prior to the patient's office visit. In this case, the physician's office creates a new patient identification number and supplies it to the patient. The office also configures the system to recognize the patient as an authorized user. With the new patient identification number and authentication information, the patient can access the system, select (only) his/her records and enter the required information. Once saved, the information is available at the physician's office site through a web browser. To maintain security, preferably the system requires the user to log-on as either a patient or a physician.

When embodied as a web/Internet based system, the clinical pathways are displayed and traversed as web pages. In a preferred embodiment, the physician cannot deviate from the clinical pathway nodes and branches. The system creates the medical record by automatically selecting and juxtaposing text strings responsive to the nodes and branches traversed along the path through the pathway. The physician can also dictate textual information (stored as a wav file in one embodiment) or enter free text via a keyboard, for appending to the end of the medical record. The final patient record text can be edited by the physician before saving as a text file and database file, and capturing the locked image file.

The web/Internet based-system does not require use of specific hardware configurations or software, avoiding down time due to local area network failures, software incompatibility induced system crashes and hardware failures such as a disk drive failure.

According to this embodiment the exemplary diagnostic clinical pathways of FIGS. 3 and 4 are stored as web pages (e.g., in text/ASCII or Microsoft Word® format) on the web server 100 of FIG. 7 for accessing by the physician (or other authorized users) via the web browser executing on the data input/output device or another computing/communications device having web access. The software programs, applets, scripts, etc. that implement the decision tree and the attendant web pages, reside on the server and are called as required responsive to the user's request to analyze a patient's condition using the clinical pathways. In one embodiment, the software controlling traversal of the decision tree is embedded within the web pages and written in HTML, including Boolean logic statements that define node information requests and direct traversal of the decision tree as the physician provides patient information. As the physician enters information, the pertinent web pages are downloaded to the browser and the physician traverses the decision tree to diagnose the patient's condition as in the embodiments described above.

Upon completion of the examination the web server 100 generates and stores the medical record. Once the medical record is generated, users, through the web browser, can download and locally store the medical record.

Any of the various letters, requests for information and requests for additional diagnostic testing that are generated by the system of the present invention can be generated by commands entered to the web server from the browser, with the requested report, information, etc. uploaded from the server to the requestor through the Internet connection. The user can also command the web server to generate the invoice, treatment plan, etc. for transmittal to the appropriate parties (for example as an email attachment). Thus the web browser provides access to the web server 100 for generating, retrieving, viewing, modifying and downloading the patient identification records, the medical records and related documents through the Internet connection.

In another embodiment, the browser's search capabilities also permit the user to search the tree structure illustrated in FIGS. 3 and 4 for pertinent diagnostic information. Using the search feature the user is not limited to the linear traversal process of the depicted pathway structure. Instead the user can search for diagnostic information using search queries (e.g., search for a specific diagnostic code in the clinical pathways) and review the retrieved information. This feature assists the physician to make a correct diagnosis since the physician can extract information that may not be readily or conveniently available when conducting a linear pathway traversal.

According to one embodiment, the web site for implementing the various features of the present invention is made available to a physician user for a monthly subscription fee. A subscription commitment allocates web site memory space to the physician for storing the records, data, and clinical diagnostic aids of the present invention. The subscription further permits the physician to search other records stored on the web site if patient confidentiality requirements are observed.

With access to the data entry and medical records system via the Internet through a common web browser executing on a conventional computer system, it is not necessary for the physician to purchase, maintain and locally store individual record creation and storage systems, reducing software office costs. Software and hardware interface problems commonly encountered when disparate hardware and software elements are required to cooperate are avoided. The physician can access the patient records from any location with web access. The web-based system also avoids costs and technical issues in creating a local area network for a physician with multiple offices.

According to another embodiment of the invention, the system web site includes hyperlinks to web sites advertising various medically-related products and services of interest to the physician and his staff. For example, convenient links are provided to prescription drug sites.

The provider of the web-based records generation and storage system derives revenue from user clicks to the hyperlinked sites. The physician's monthly subscription fee is determined by the number of hyperlinked sites visited per month, and/or the advertisers pay the system provider based on the number of click-throughs to the advertising site.

Hyperlinks can also be placed within the diagnostic pathway and/or at the applicable intermediate or end nodes, allowing the physician to click the link to view additional information about the conditions associated with that node, including drugs and devices that may alleviate the indicated condition. The linked sites may provide detailed technical information designed to further educate the physician and the patient about the condition, and advertising material to promote use of the advertised medication.

Medical device and drug suppliers can be granted access to the patient medical records for conducting post-market surveys to determine the efficacy, complications, reactions, effects, etc. of the devices or drugs used by patients. The stored records are searched (using key words, for example) and relevant record portions retrieved. Record confidentiality is maintained since the patient is not identified in the retrieved record; the record including only the patient identification number, record number or other patient identifying indicia. By excluding patient identification from the record, data mining of the patient records is easily facilitated.

FIG. 8 illustrates in block diagram form another embodiment of the present invention, wherein the data input/output device 10 provides medical/health information to an analysis component 150 for implementing the clinical pathways. In web/Interned embodiment, the analysis component is disposed within the web server 100 of FIG. 7. After the pathways have been traversed and an end point reached, the derived medical information is supplied to an output component 152 for generating the medical record (in soft and/or hard copy form). The record is stored in a storage component 154 for later retrieval by operation of a retrieval component 158 bidirectionally responsive to the storage component via a wired or wireless network, including the Internet. The elements of the FIG. 8 embodiment can be networked or connected by a direct wired or wireless connection.

The various software features of the present invention are implemented in a microprocessor and associated memory elements within a client computer and/or within a central repository. The described software steps form a software program stored in the memory element and operable in the microprocessor. When implemented in a microprocessor, program code configures the microprocessor to create logical and arithmetic operations to process the software steps. The invention may also be embodied in the form of computer program code written in any of the known computer languages containing instructions embodied in tangible media such as floppy diskettes, CD-ROM's, hard drives, DVD's, removable media or any other computer-readable storage medium. When the program code is loaded into and executed by a general purpose or a special purpose computer, the computer becomes an apparatus for practicing the invention. The invention can also be embodied in the form of a computer program code, for example, whether stored in a storage medium loaded into and/or executed by a computer or transmitted over a transmission medium, such as over electrical wiring or cabling, through fiber optics, or via electromagnetic radiation, wherein when the computer program code is loaded into and executed by a computer, the computer becomes an apparatus for practicing the invention.

An apparatus, method and computer program product have been described as useful for generating a patient's medical records. While specific applications and examples of the invention have been illustrated and discussed, the principals disclosed herein provide a basis for practicing the invention in a variety of ways and in a variety of circuit structures. Numerous variations are possible within the scope of the invention. The invention is limited only by the claims that follow.

What is claimed is:

1. An apparatus for producing a patient medical record, comprising:
an information receiving component operative by an inputting user who supplies patient health information to the receiving component;
an analysis component receiving the health information from the receiving component, the analysis component traversing a traversal path through a clinical pathway responsive to the health information, wherein the clinical pathway comprises hierarchical nodes joined by interconnecting branches;
an output component generating the medical record in response to the traversal path; and
a storage component storing the medical record as a data file.

2. The apparatus of claim 1 wherein the data file comprises at least one of an image file, a database file and a text file, and wherein the text file comprises an ASCII format text file or a Microsoft Word format text file.

3. The apparatus of claim 1 wherein the analysis component allows the inputting user edits and appends information to the medical record prior to the output component storing the medical record.

4. The apparatus of claim 1 wherein the receiving component at a first location is connected to the analysis component at a second location through a wired or wireless connection for communicating information therebetween.

5. The apparatus of claim 4 wherein the network comprises an Internet.

6. The apparatus of claim 1 wherein the analysis component prompts the inputting user to enter health information to the information receiving component at the nodes of the traversal path, and wherein a plurality of candidate branches extend from each node, and wherein a selected branch from among the candidate branches is responsive to health information supplied.

7. The apparatus of claim 1 wherein one or more of the nodes comprises a link to an information source, and wherein the inputting user activates the link to review the additional information, and wherein the additional information comprises technical medical information or advertising information.

8. The apparatus of claim 7 wherein the link comprises a hyperlink.

9. The apparatus of claim 1 wherein the storage component comprises a web server, and wherein the data file is retrievable from the web server from a web browser.

10. The apparatus of claim 9 wherein a retrieving user retrieves the medical record operating a web browser accessing the web server, and wherein the apparatus authenticates the retrieving user prior to retrieving the medical record.

11. The apparatus of claim 9 wherein the web server stores a plurality of medical records as data files searchable by a search engine.

12. The apparatus of claim 1 further comprising a retrieval component, wherein in response to a retrieving user's request for a medical record, the retrieval component supplies the medical record to the retrieving user, wherein the retrieving user had been previously granted a read-only permission or permission to append to the medical record, and wherein the retrieval component authenticates the retrieving user prior to supplying the medical record.

13. The apparatus of claim 12 wherein the retrieval component supplies the retrieving user with a photographic image of a patient whose medical record has been requested, wherein the retrieving user confirms the image depicts the patient whose record has been requested and in response thereto the retrieval component supplies the medical record.

14. The apparatus of claim 1 wherein the medical record comprises patient indicia and excludes patient identification information except the patient indicia.

15. The apparatus of claim 14 wherein the patient indicia comprises a unique sequence of characters assigned to the patient.

16. The apparatus of claim 14 wherein the storage component separately stores the patient medical record and a patient identification record comprising patient identification information and the patient indicia.

17. The apparatus of claim 14 wherein the medical record is reviewable by a third party without requiring prior patient approval.

18. The apparatus of claim 1 wherein the information input device comprises a touch-activated display screen for entering the patient's health information by touching a selected region of the touch-activated display screen.

19. The apparatus of claim 1 wherein the analysis component prompts for patient health information at the nodes, and wherein in response to provided patient health information an output branch from the node is selected, the output branch leading to a subsequent node.

20. The apparatus of claim 19 wherein the analysis component comprises a software program, and wherein each node comprises a web page.

21. The apparatus of claim 1 wherein the medical record includes one or more of the patient's medical history, examination findings, procedure findings, scheduled procedures, impressions, diagnoses, treatment plan, diagnostic and procedure codes, and billing information.

22. The apparatus of claim 1 wherein the medical record is responsive to the branches and nodes of the traversed path.

23. The apparatus of claim 1 wherein an end node of the traversed path indicates one or more of a nature of the disease, condition or injury, adverse outcomes of the disease, adverse outcomes of the treatment, differential diagnosis, risk factors and history.

24. The apparatus of claim 1 wherein the clinical pathway comprises an insurance carrier approved clinical pathway.

25. The apparatus of claim 1 wherein the analysis component comprises logic operations for determining an output branch from among a plurality of branches extending from a node, the output branch responsive to the health information supplied at the node.

26. The apparatus of claim 1 wherein the inputting user comprises the patient.

27. The apparatus of claim 1 wherein the analysis component further comprises a searching component for searching the clinical pathway responsive to user supplied search queries.

28. The apparatus of claim 1 wherein the storage component stores the medical record on a removable storage media.

29. The apparatus of claim 1 wherein the clinical pathway comprises one or more of patient progress notes, care plan notes, physical therapy procedures and allied health care services.

30. A method for generating a patient's medical record, comprising:
issuing prompts for entry of patient health information, wherein each prompt is associated with a node of a clinical pathway;
entering the patient health information in response to the prompts, wherein data entered responsive to a current prompt at a current node generates a subsequent prompt associated with a subsequent node according to a path of the clinical pathway from the current node to the subsequent node;
producing the medical record responsive to nodes encountered and heath information entered along the path traversed through the clinical pathway; and
storing the medical record as a data file.

31. The method of claim 30 wherein the data file comprises at least one of an image file, a database file and a text file.

32. The method of claim 30 wherein the step of entering comprises entering health information through keystrokes on a keypad, spoken text or a touch-activated display screen.

33. The method of claim 30 wherein the clinical pathway comprises a plurality of nodes and one or more branches extending from each node, and wherein as health information is entered during the step of entering at a current node, a branch is selected extending from the current node to the subsequent node, and wherein successive branches form a path through the clinical pathway.

34. The method of claim 30 comprising a software program wherein each node is represented by a file in the software program.

35. The method of claim 30 further comprising a step of generating documents in response to the medical record.

36. The method of claim 30 further comprising accessing the medical record from a web browser.

37. The method of claim 30 further comprising searching data files comprising medical records using a web browser search engine.

38. The method of claim 30 wherein the step of entering the patient's health information comprises a medical services professional entering the information or a patient entering the information.

39. The method of claim 30 further comprising accessing the medical record from a web browser and authenticating an accessing party prior to transmitting the medical record to the web browser.

40. The method of claim 30 further comprising generating a patient's identification information record comprising patient identification information, wherein the patient's medical record comprises unique patient indicia associated with the patient's identification information record and the patient's medical record lacks patient identification information.

41. The method of claim 30 further comprising supplying a photograph of a patient prior to supplying the patient's medical record to a retrieving user, wherein after the retrieving user confirms that the photograph depicts the patient, the medical record is provided.

42. The method of claim 30 further comprising providing access to additional medical information at one or more nodes of the clinical pathway.

43. A method for use by a subscriber for generating, storing and retrieving medical records, comprising:
allocating memory storage to the subscriber;
supplying patient medical information to an input component;
generating a medical record responsive to the patient medical information and to a clinical pathway;
storing the medical record; and
providing the subscriber with access to the medical record via a web browser.

44. The method of claim 43 further comprising providing links to information sources within the clinical pathway.

45. A computer program product for producing a patient medical record, the computer program product comprising:
a storage medium readable by a computer processor and storing program code for execution by the computer processor, the program code comprising:
receiving the patient health information in a data input device, wherein each data entry generates a prompt for the next data entry, wherein a generated prompt is derived from a plurality of clinical pathways each comprising a plurality of hierarchical nodes and interconnecting branches;
producing the medical record in response to a path traversed through the clinical pathway; and
storing the medical record as a data file.
